(19) United States
(12) Patent Application Publication
(10) Pub. No.: US 2024/0234757 A1
(43) Pub. Date: Jul. 11, 2024

(54) HIGH EFFICIENCY FUEL CELL AIR MANAGEMENT SYSTEM

(71) Applicant: Eaton Intelligent Power Limited, Dublin (IE)

(72) Inventors: Doug HUGHES; Milos TOULEC, Ricany (CZ); Brandon BILLER; Vishal KHANDELWAL, Kalyan (IN); Matthew FRANK; Fabiano CONTARIN, Torino (IT); Ondrej BOLEHOVSKY, Praha (CZ); Mihai DOROBANTU; Evan REICH

(21) Appl. No.: 18/563,013

(22) PCT Filed: May 23, 2022
(86) PCT No.: PCT/EP2022/025238

§ 371 Date: Nov. 21, 2023

(30) Foreign Application Priority Data
May 21, 2021 (IN) 202111022706

(51) Int. Cl. H01M 8/04007; H01M 8/04029; H01M 8/04111; H01M 8/04119; H01M 8/0432; H01M 8/0438; H01M 8/04828

(52) U.S. Cl. CPC H01M 8/04059; H01M 8/04029; H01M 8/04111; H01M 8/04164; H01M 8/04335; H01M 8/04395; H01M 8/04835

(57) ABSTRACT

A fuel cell air management system includes a compressor receiving ambient air at a compressor inlet and supplying compressed air at a compressor outlet. A mechanical power transmission is connected to an electric machine. The mechanical power transmission is operatively connected to the compressor. An expander is operatively connected to the mechanical power transmission. A recuperator is connected to the compressor outlet. The recuperator includes a recuperator inlet and a recuperator outlet. An intercooler is coupled to the recuperator outlet. A fuel cell stack is connected to an intercooler outlet. The fuel cell stack includes a fuel cell outlet connected to the recuperator and the recuperator includes an exhaust connected to the expander. A water separator is connected to an outlet of the expander. The water separator is coupled to a pump metering a specified dose of water to a specified location selected from the compressor inlet, the compressor outlet, the recuperator outlet or combinations thereof.

### FIELD OF THE INVENTION

The invention relates to air handling systems for fuel cells.

### BACKGROUND OF THE INVENTION

Traditional fuel cell air systems that utilize centrifugal style compressors and expanders can be sensitive to condensation. In order for the centrifugal style system to meet the fuel cell membrane humidity requirements, a humidifier and dryer are used resulting in pressure losses. The resulting pressure loss is undesirable. Further, the addition of the humidifier and dryer result in increased size and weight of a system.

There is a need for improved fuel cell air systems that may increase performance, increase durability, or otherwise increase efficiency of a fuel cell and vehicle.

### SUMMARY OF THE INVENTION

In one aspect, there is disclosed a fuel cell air management system that includes a compressor receiving ambient air at a compressor inlet and supplying compressed air at a compressor outlet. A mechanical power transmission is connected to an electric machine. The mechanical power transmission is operatively connected to the compressor. An expander is operatively connected to the mechanical power transmission. A recuperator is connected to the compressor outlet. The recuperator includes a recuperator inlet and a recuperator outlet. An intercooler is coupled to the recuperator outlet. A fuel cell stack is connected to an intercooler outlet. The fuel cell stack includes a fuel cell outlet connected to the recuperator and the recuperator includes an exhaust connected to the expander. A water separator is connected to an outlet of the expander. The water separator is coupled to a pump metering a specified dose of water to a specified location selected from the compressor inlet, the compressor outlet, the recuperator outlet or combinations thereof.

In another aspect there is disclosed a method of operating a fuel cell air management system including the steps of: providing a fuel cell system comprising a compressor receiving ambient air at a compressor inlet and supplying compressed air at a compressor outlet; a mechanical power transmission connected to an electric machine, the mechanical power transmission operatively connected to the compressor; an expander operatively connected to the mechanical power transmission; a recuperator connected to the compressor outlet, the recuperator including a recuperator inlet and a recuperator outlet; an intercooler coupled to the recuperator outlet; a fuel cell stack connected to an intercooler outlet, the fuel cell stack including an outlet connected to the recuperator, the recuperator including an exhaust connected to the expander; a water separator connected to an outlet of the expander, the water separator coupled to a pump metering a specified dose of water to a specified location; compressing air in the compressor; recovering heat from the compressed air in the recuperator and transferring the heat to the exhaust of the recuperator; and expanding the exhaust of the recuperator in the expander transferring mechanical power through the mechanical power transmission to the compressor.

### BRIEF DESCRIPTION OF THE DRAWINGS

FIG. 1 is a functional schematic of an air management system for a vehicle that includes a fuel cell;

FIG. 2A is a graph illustrating power consumption at 100% flow conditions;

FIG. 2B is a graph illustrating power consumption at 50% flow conditions; and

FIG. 3 is a functional schematic of an air management system including a plurality of motors for a vehicle that includes a fuel cell;

FIG. 4 is a partial functional schematic of an air management system with no water dosing;

FIG. 5 is a partial functional schematic of an air management system with water dosing prior to a recuperator;

FIG. 6 is a partial functional schematic of an air management system with water dosing after a recuperator.

### DETAILED DESCRIPTION OF THE PREFERRED EMBODIMENTS

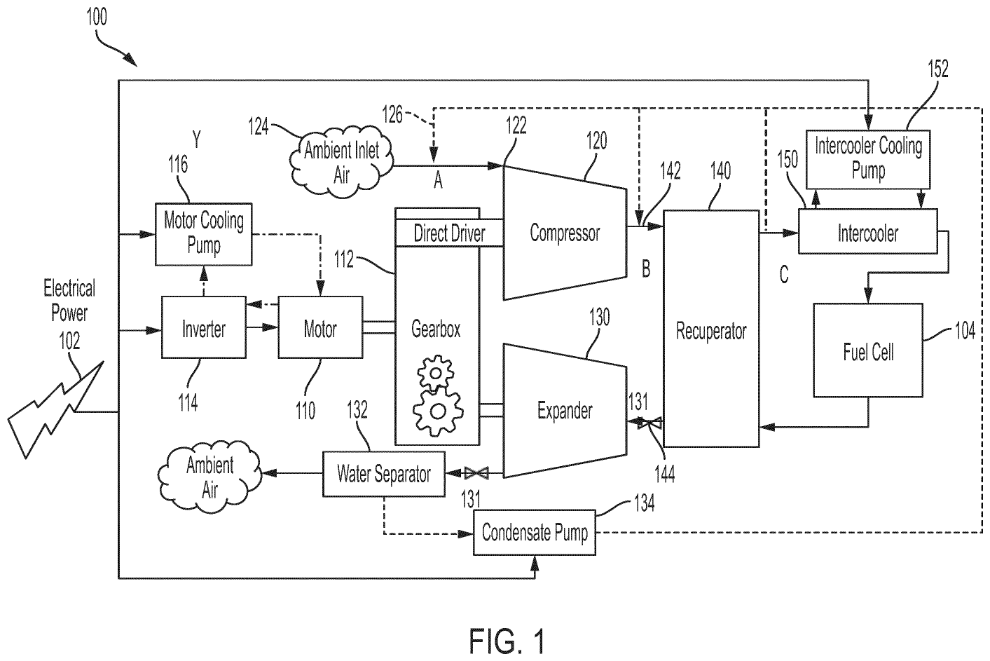

FIG. 1 depicts a functional schematic of an air management system 100 for a vehicle that includes a fuel cell 104. The air management system 100 may manage air pressure, heat flow, and water injection/separation between components as disclosed herein. Moreover, the air management system 100 may achieve an efficient power consumption to meet requirements of high efficiency systems. The air management system 100 may primarily include an electric machine 110, mechanical power transmission 112, compressor 120, expander 130, water separator 132, recuperator 140, and an intercooler 150. The air management system 100 may be coupled with a power source 102 and a fuel cell 104.

The electric machine 110 may be configured to drive both the compressor 120 and the expander 130 via a mechanical power transmission 112. The electric machine 110 may be powered by the power source 102. The electric machine 110 may include or be coupled to an inverter 114, which receives power from the power source 102. The inverter 114 may include power electronics for the electric machine 110. The inverter 114 may be additionally coupled to a cooling pump 116. The cooling pump 116 may be powered by the power source 102 and may provide cooling for the electric machine 110, the inverter 114, or both. In at least one embodiment, the electric machine 110 includes a flux traction motor, such as a power-dense axial flux traction motor, and the inverter 114 includes a silicon-carbide (SiC) inverter system. The flux traction motor and SiC inverter system may be appropriately scaled and may maintain an appropriate efficiency and power density. For instance, axial flux rotors may move cooling requirements to along radial positions. Moreover, the cooling pump 116 may include a liquid cooling system that may cool the electric machine 110, the inverter 114, or both. It is noted that other motors, inverters, or cooling systems may be utilized. For example, a compressor flow cooling system may be utilized.

In some embodiments, the cooling pump 116 may be configured to cool the electric machine 110 and/or other devices, such as the inverter 114. Sharing of the cooling pump 116 resources may allow for one cooling loop between the inverter 114 and the electric machine 110, which may provide improved and more efficient cooling, while reducing components and energy consumption.

Still referring to FIG. 1, the mechanical power transmission 112 can include a gear set housed within a housing. Alternatively, the mechanical power transmission 112 may include a single shaft shared by the electric machine 110, compressor 120 and expander 130.

The gear set includes appropriate gears, such as one or more timing gears. In embodiments, the gear set enables mechanical power transmission from the expander 130 to the compressor 120 to reduce loss. In an example, the gear set may include a low-friction gear train configured to efficiently transfer mechanical power from the expander 130.

Additionally or alternatively, the gear set is configured to allow different operating speeds such that the expander 130 and the compressor 120 are decoupled and may operate at appropriate speeds. Moreover, the expander 130 and compressor 120 may be driven at different speeds, torques, times, or other operating parameters. The expander 130 may operate more efficiently at a first speed for recovery and the compressor 120 may operate more efficiently at a second speed, where the first speed and the second speed are different. Use of a single motor 110 to drive the expander 130 and compressor 120 may reduce overall system size.

In an embodiment, the mechanical power transmission 112 can include a gear train with a fixed ratio coupling the expander 130 and the compressor 120. For example, a 5:1 ratio between the expander 130 output and the compressor 120 input may be utilized. The expander 130 output may be taxed by about 2%. While the flow is generally equal, the speed ratio is a function of inflow speeds and expansion/compression ratio. It is noted that the gear ratio may include other appropriate ratios that prevent or reduce the chances that the compressor 120 drives the expander 130.

Moreover, embodiments may include a continuously variable transmission or differential or multiple speed transmissions gear train to change the speed match based on operating conditions. The expander 130 output may be taxed 3-10% depending on implementation and operating point.

In at least some embodiments, the expander 130 may include a Roots, screw or a variable geometry turbine expander. A Roots-style expander may receive wet exhaust (water vapor, liquid water, and air) from the recuperator 140. As described herein, the wet exhaust may be heated. The expander 130 may be fluidly connected to a water separator 132. The water separator 132 can separate water expelled by the expander 130. The water separator 132 may be coupled to a condenser pump 134 that may meter the water to various locations in order to control the humidity in the fuel cell 104, as well as act as a heat transfer medium, as will be discussed in more detail below. Alternatively, the water from the water separator may be feed to the various locations passively, such as by gravity.

Referring to FIG. 1, water may be introduced upstream of the compressor 120 as denoted by the location A, or in an inflow to the inlet 142 of the recuperator 140 denoted by the location B. This may increase compressor 120 efficiency and may wet the intake of the fuel cell 104 to control the humidity in the fuel cell 104.

When water is introduced at location A, the water may be vaporized by the heat produced by the compressor 120, cooling the compressor 120, and thus reducing internal thermal expansion. It is further noted that, this may allow for reduced rotor and housing clearances which can lead to higher efficiencies. The water may act as a vapor barrier, making clearances more effective. Additionally or alternatively, the water serves to cool trapped air within the internal volume of the compressor 120, allowing for more mass in constant volume, increasing the pressure within the fuel cell 104, increasing the isentropic efficiency and may provide humidity for the fuel cell 104, without the need for a separate humidifier.

When water is introduced at location B, the water may provide humidity for the fuel cell 104, without the need for a separate humidifier as well as regulate the temperature of air entering the recuperator 140.

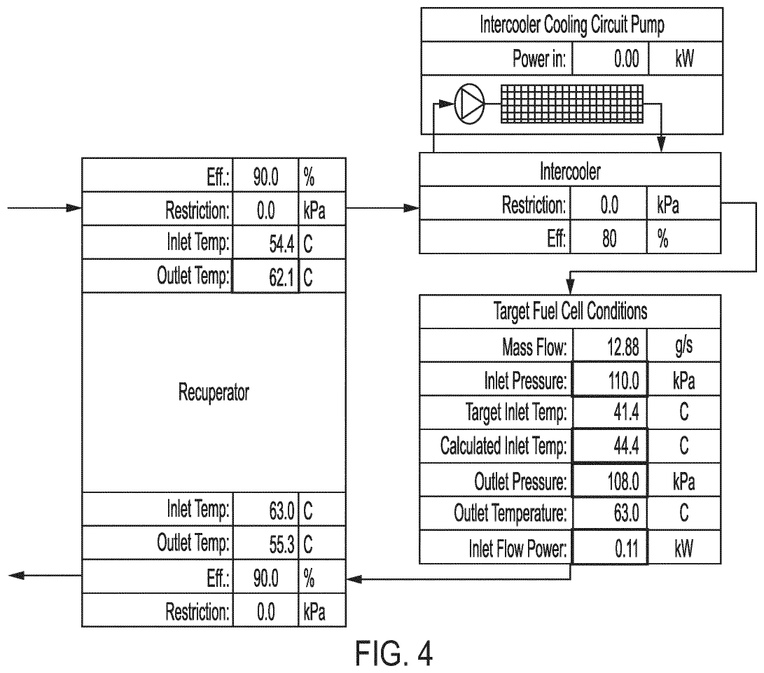

Referring to FIG. 4, there is shown a computer model calculation of the temperature and flow parameters of the recuperator 140, intercooler 150, and fuel cell 104 when no water is introduced. The computer model is based upon an idling test point. The idling test point provides the mass flow and pressure for the model. Further, the models at the various injection points assumes 100 percent relative humidity in the model.

The recovery of heat from the recuperator may be based on the equation: q_max=C_min*(T_hi−T_ci). Q_max is the maximum possible heat transfer, C_min is the minimum heat capacity between the hot side inlet temperature (T_hi) and the cold side inlet temperature (T_ci). In the system T_ci is held relatively constant due to the fuel cell regulating its stack temperature. Assuming that C_min stays relatively constant, increasing the temperature, T_hi increases the maximum possible heat transfer of the recuperator, and thus making the recuperator more effective in the system. Injecting water into an air stream lowers air temperature and thus injecting after the recuperator will maximize T_hi.

As can be seen in FIG. 4, the outlet temperature from the recuperator 140 to the intercooler 150 is 62.1° C. and the intercooler 150 further reduces the temperature to the inlet of the fuel cell 104 to 44.4° C. The outlet temperature from the recuperator 140 to the expander 130 is 55.3° C. The outlet temperature from the fuel cell 104 to the recuperator 140 is 63° C. As can be seen in this configuration, the recuperator 140 is not operating efficiently as the direction of heat transfer is opposite of the recuperator's purpose.

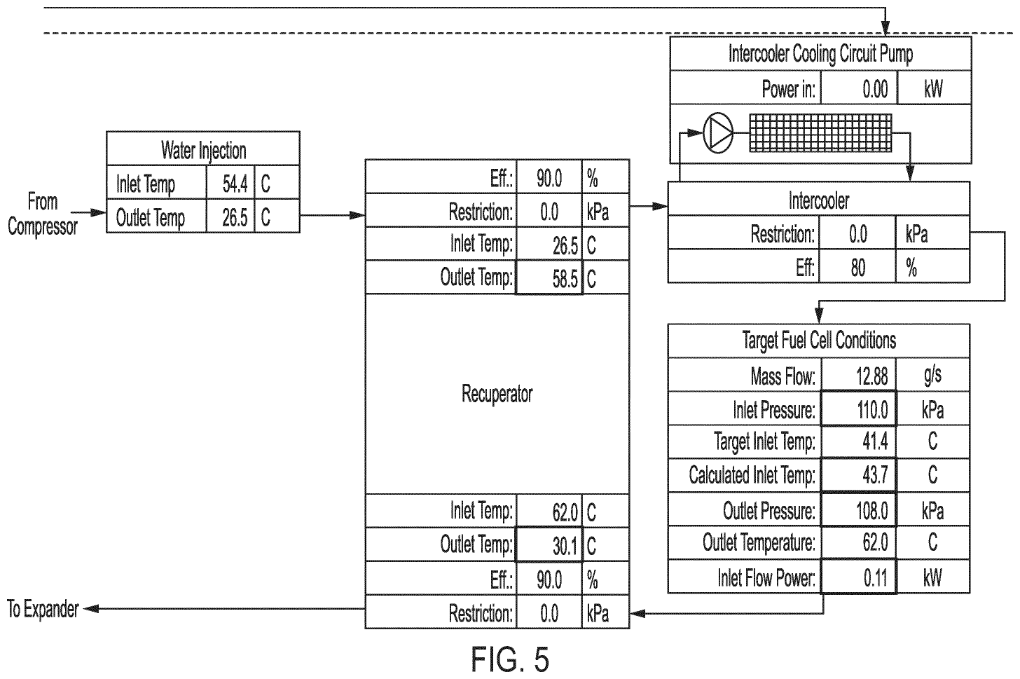

Referring to FIG. 5, there is shown a computer model calculation of the temperature and flow parameters of the recuperator 140, intercooler 150, and fuel cell 104 when water is introduced at location A or B. As can be seen in the figure, the introduction of water at location A and B reduces the inlet temperature from the compressor 120 to the recuperator 140 to 26.5° C. and the outlet temperature from the recuperator 140 to the intercooler 150 to 58.5° C. When water is introduced at location A or B, it results in a reduction of the outlet temperature from the recuperator 140 to the expander 130 to 30.1° C. in comparison to the model shown in FIG. 4 for dry air without the introduction of water which has an outlet temperature of 55.3° C.

When water is introduced at location C, the water may provide humidity for the fuel cell 104, without the need for a separate humidifier as well as regulate the temperature of air entering the intercooler 150.

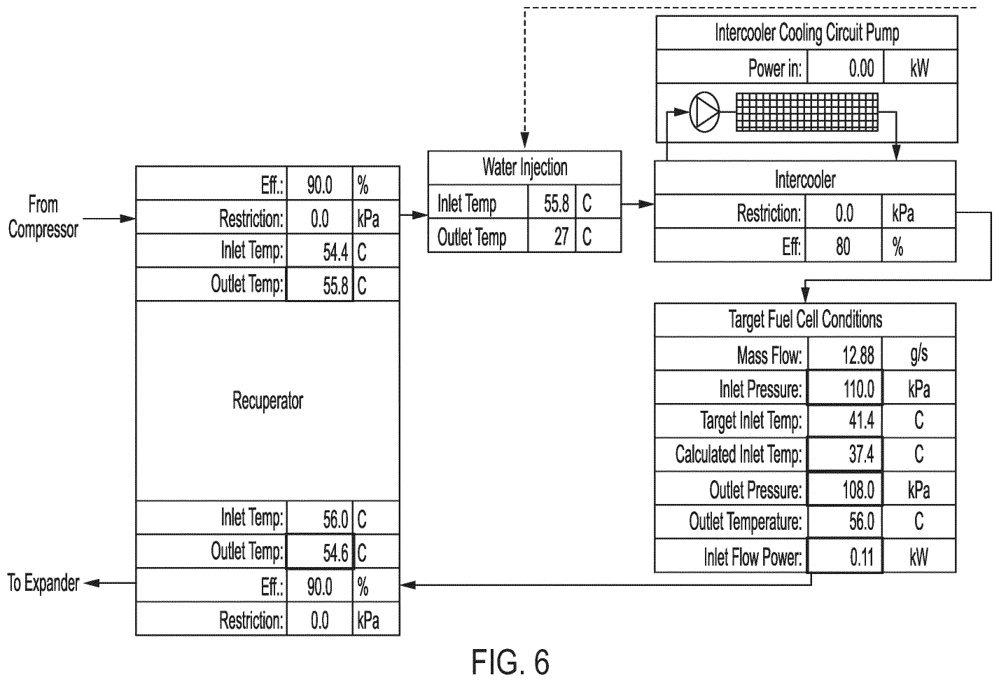

Referring to FIG. 6, there is shown a computer model calculation of the temperature and flow parameters of the recuperator 140, intercooler 150, and fuel cell 104 when water is introduced at location C. As can be seen in the figure, the introduction of water at location C reduces the inlet temperature from the recuperator 140 to the intercooler 150 to 27° C. The intercooler acts as a heater and raises the temperature of the air or fluid to the fuel cell to 37.4° C. The temperature from the recuperator 140 to the expander 130 is 54.6° C., which is greater than the temperature shown in FIG. 5 of 30.1° C. Introduction of water at location C may provide a greater recovery of energy from the recuperator 140 to the expander 130.

In another aspect, water may be introduced at both location A and at location C. In this configuration, water introduced at A may increase the efficiency of the compressor 120 and water introduced at location C can increase the recovery of energy from the recuperator 140 to the expander 130. In one aspect, the water at location A may be in an amount to optimize the increase in compressor efficiency and the remainder of the metered water may be provided at location C to allow for the increased heat transfer and recovery of energy described above.

The amount of water metered to the various locations is a function of the pressure, flow rate of air, temperature and the operating percentage of the fuel cell 104. As a general trend, more water is required at higher flow rates and operating percentages of the fuel cell 104. The water supplied under various conditions can be determined by knowing the pressure, temperature and flow rate of the fuel cell and then determining the amount of water for the specified fuel cell type which is known for the specified operating conditions. In this manner, the amount of humidity required for efficient operation of the fuel cell 104 is provided without a separate humidifier. Separation of the expander 130 from the water separator 132 may allow for maintaining of a target operating pressure within the fuel cell 104 and avoid a drop in pressure and reduce the recoverable pressure loss. For instance, the water separator 132 may be downstream of the expander 130 such that embodiments maintain high pressure ahead of expander 130, which may result in more energy available to the expander 130. It is further noted that the expander 130 may have increased efficiency through enhanced sealing by water vapor. Further, a colder exhaust stream with increased fraction of liquid water may be achieved.

In at least some embodiments, the expander 130 recovers part of the compression work by expanding the air exhausted by the fuel cell 104, as described herein. Recovering the work may allow for lower power consumption of the fuel cell system.

The compressor 120 may include a positive displacement device, such as Roots machine driven by the motor 110 via the mechanical power transmission 112. Alternatively, a screw, centrifugal, or variable geometry turbine may be utilized. The compressor 120 includes a housing that defines an internal volume. The internal volume of the compressor 120 includes rotors that are selectively driven by the motor 110. The internal volume is further fluidly coupled to an inlet 142 of the recuperator 140.

The compressor 120 includes an inlet 122 that may receive ambient air 124 and a fluid 126. For instance, the inlet 122 may receive water injected from a condenser pump 134. The compressor 120 forces an air flow through the fuel cell 104 and raises the pressure of such air flow such that higher power is generated by the fuel cell 104. Integration of water management with the compressor 120 may reduce system pressure drops and increase compression ratio and efficiency, and allow for non-external water sources that would require refilling or a humidifier that requires additional space and energy.

Referring to FIG. 1, the recuperator 140 may transfer heat from the fuel cell 104, such as from an inlet 142 to an exhaust 144. The recuperator 140 may include a heat transfer device such as a cross-flow heat exchange device. Heat may be transferred to the expander 130. The expander 130 may utilize the transferred heat as energy thereby increasing enthalpy while also reducing a load on an intercooler 150 and intercooler pump 152 coupled to the fuel cell 104. Further, the recuperator 140 may transfer heat generated by the compressor 120 to useful energy for the expander 130 which improves system efficiency.

In an embodiment, the recuperator 140 includes a counter flow heat exchanger that cools inflow received in the inlet 142, and transfers that heat to an exhaust flow flowing through the exhaust 144. Accordingly, lost work in cooling the inflow by the intercooler 150 may be avoided or reduced and additional work of expander 130 may be added. The power requirements of the air management system 100 may improve efficiency in comparison to traditional systems.

The intercooler 150 may include a heat exchanger configured to cool or heat inflow to the fuel cell 104. In embodiments, the intercooler may include an intercooler pump 152 coupled to the power source 102. The intercooler 150 may further reduce the temperature of the air out of the recuperator 140, before entering the fuel cell 104, to a point that is suitable for appropriate operation of the fuel cell 104.

Still referring to FIG. 1, additive manufacturing processes may be utilized to build various components to reduce component sizes while balancing heat transfer effectiveness and flow restriction by considering entropy reduction. In examples, an additive manufacturing system may utilize finite element and computational fluid dynamics techniques, estimate recuperator 140 size by scaling the component results, and estimate cost and manufacturability. A resulting recuperator 140 may include a geometry designed to balance size and heat transfer efficiency as well as provide a minimum flow restriction.

Further, in some traditional systems, compressors deliver the flow and a pressure regulator (throttle) at the outlet restricts the air path to increase pressure (limit flow). These traditional systems attempt to control the mass flow rate and pressure in an air path. However, traditional systems are inefficient.

Embodiments described herein eliminate throttling in the system and de-couple the expander 130 from compressor 120. As described herein, the expander 130 can include a Roots machine, screw or variable geometry turbine expander with a motor/generator unit independent from the compressor 120 to both limit the flow and harvest additional energy. In at least some embodiments, a control unit may control the expander 130 and the compressor 120 to coordinate a system level control for fast and efficient operation. The control unit can include an electronic control unit comprising a computer processor coupled to a non-transient memory device. The memory device may store computer executable instructions. Additionally, a pressure regulating valve 131 may be positioned at the inlet of the expander 130 or at the outlet of the expander 130 to control the flow within the air management system.

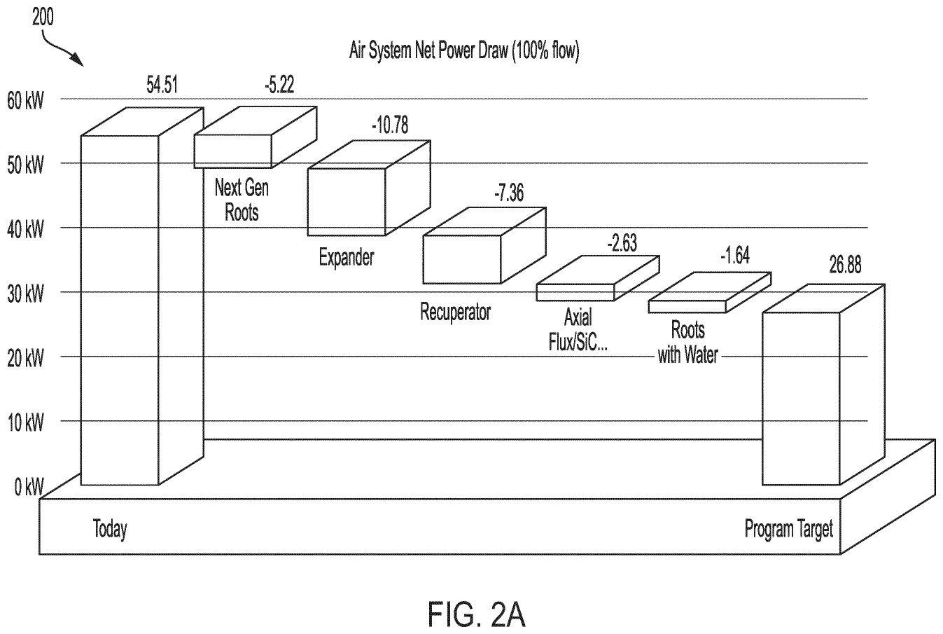

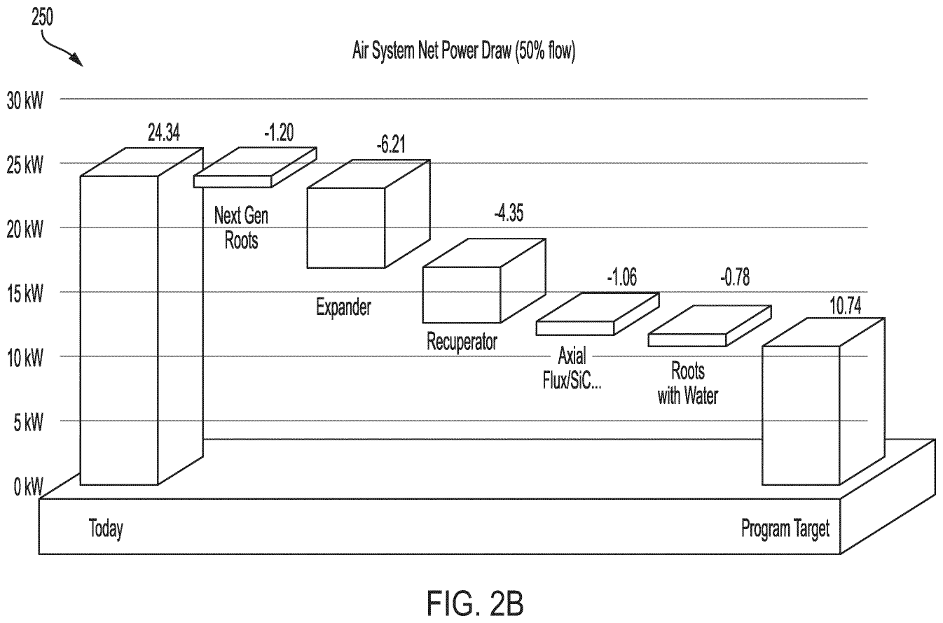

Referring now to FIGS. 2A-2B, there are graphs 200 and 250 illustrating power consumption at 100% and 50% flow conditions, respectively based on the computer models described above. The bar on the furthest left of the Figures represents the total power consumption of a typical prior art system at around 54.51 KW and 24.34KW at 100 percent flow and 50 percent flow respectively. The bar on the far right represents the net power draw of the embodiments described herein at 26.88 KW and 10.74KW at 100 percent flow and 50 percent flow respectively. The structures and embodiments described above result in a cumulative reduction of the power consumption of the system. Embodiments disclosed herein may deliver 50-55% improvement in air system power consumption, equivalent to a 9% fuel cell output improvement.

The proportional contributions of the various structures to the net power draw improvements are shown in the figures. The Roots device including the efficient motor and cooling described above may contribute a net power savings of about 5.22% and 1.2% at 100 percent flow and 50 percent flow respectively. The use of the expander described above including having water in the expander and removing the need for a dryer in prior art systems may contribute a net power savings of about 10.78% and 6.21% at 100 percent flow and 50 percent flow respectively. The use of the compressor described above including having water in the compressor may contribute a net power savings of about 1.64% and 0.78% at 100 percent flow and 50 percent flow respectively. The use of the recuperator described above may contribute a net power savings of about 7.35% and 4.35% at 100 percent flow and 50 percent flow respectively. The use of the axial flux motor and cooling systems described above may contribute a net power savings of about 2.63% and 1.06% at 100 percent flow and 50 percent flow respectively.

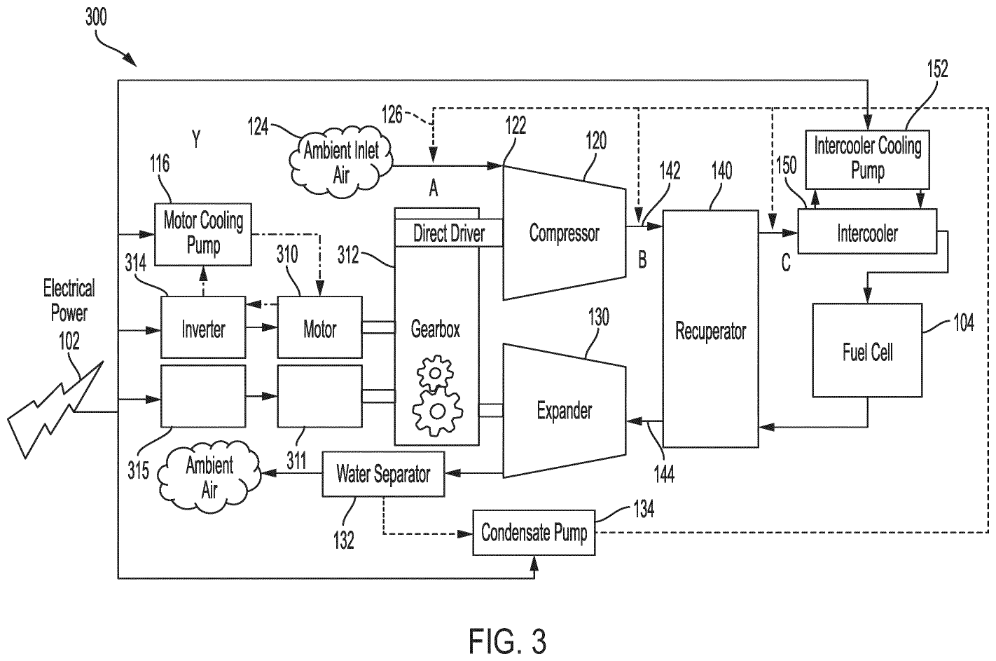

Turning to FIG. 3, depicted is a functional schematic of an air management system 300 for a vehicle that includes a fuel cell 104. The air management system 300 may manage air pressure, heat flow, and water injection/separation between components as disclosed herein. Moreover, the air management system 300 may achieve an efficient power consumption to meet requirements of high efficiency systems. The air management system 300 may include some similar or the same components as the air management system 100, as denoted by like named components.

In embodiments, however, the compressor 120 may be driven by an electric machine 310 coupled to an inverter 314. The expander 130 may be driven by a separate or different electric machine 311 coupled to an inverter 315. One or more mechanical power transmissions 312 may be provided to transmit power from the motors 310/311 to the compressor 120 or expander 130. It is further noted that the mechanical power transmission 312 may include a gear train or transmission that selectively allows one or both of the motors 310/311 to operatively drive the compressor 120, the expander 130, or both compressor 120 and the expander 130. In one aspect, the use of separate electric machines for the expander 130 and the compressor 120 allows for independent drive of both of the devices allowing control of the air flowrate and pressure through the use of the compressor 130 and expander 120. In such a configuration, the mechanical power transmission 312 linking the compressor 120 and expander 130 may be eliminated, such that each of the devices are directly driven. Such a configuration may allow for the removal of a pressure-regulating valve and still have control of the air flowrate and pressure.

1. A fuel cell air management system comprising:
a compressor receiving ambient air at a compressor inlet and supplying compressed air at a compressor outlet;
a mechanical power transmission connected to an electric machine, the mechanical power transmission operatively connected to the compressor;
an expander operatively connected to the mechanical power transmission;
a recuperator connected to the compressor outlet, the recuperator including a recuperator inlet and a recuperator outlet;
an intercooler coupled to the recuperator outlet;
a fuel cell stack connected to an intercooler outlet, the fuel cell stack including a fuel cell outlet connected to the recuperator, the recuperator including an exhaust connected to the expander;
a water separator connected to an outlet of the expander, the water separator metering a specified dose of water to a specified location selected from the compressor inlet, the compressor outlet, the recuperator outlet or combinations thereof supplying humidity to the fuel cell stack.

2. The fuel cell air management system of claim 1 wherein the compressor comprises a Roots machine.

3. The fuel cell air management system of claim 1 wherein the expander comprises a Roots machine.

4. The fuel cell air management system of claim 1 wherein the mechanical power transmission transfers mechanical power from the expander to the compressor reducing a required input from the electric machine.

5. The fuel cell air management system of claim 1 wherein the mechanical power transmission decouples the expander and the compressor wherein the expander and compressor are driven at different speeds.

6. The fuel cell air management system of claim 1 wherein the mechanical power transmission includes a fixed speed ratio gear train and a pressure-regulating valve.

7. The fuel cell air management system of claim 1 wherein the mechanical power transmission includes a differential gearing and a pressure-regulating valve.

8. The fuel cell air management system of claim 1 wherein the recuperator transfers heat from the compressor outlet to an expander inlet.

9. The fuel cell air management system of claim 1 further including a cooling pump connected to the electric machine and an inverter of the electric machine.

10. The fuel cell air management system of claim 1 further including a separate electric machine and inverter connected to the expander.

11. The fuel cell air management system of claim 10 further including a separate mechanical power transmission connected to the separate electric machine.

12. The fuel cell air management system of claim 10 wherein the separate electric machine includes a generator, the generator connected to the expander transferring mechanical power from the expander to the generator generating electrical power.

13. A method of operating a fuel cell air management system comprising the steps of:
providing a fuel cell system comprising a compressor receiving ambient air at a compressor inlet and supplying compressed air at a compressor outlet; a mechanical power transmission connected to an electric machine, the mechanical power transmission operatively connected to the compressor; an expander operatively connected to the mechanical power transmission; a recuperator connected to the compressor outlet, the recuperator including a recuperator inlet and a recuperator outlet; an intercooler coupled to the recuperator outlet; a fuel cell stack connected to an intercooler outlet, the fuel cell stack including an outlet connected to the recuperator, the recuperator including an exhaust connected to the expander; a water separator connected to an outlet of the expander, the water separator metering a specified dose of water to a specified location;
compressing air in the compressor;
recovering heat from the compressed air in the recuperator and transferring the heat to the exhaust of the recuperator;
expanding the exhaust of the recuperator in the expander transferring mechanical power through the mechanical power transmission to the compressor.

14. The method of operating a fuel cell air management system of claim 13 including the steps of:
determining a temperature of air in the fuel cell system;
determining a pressure of air in the fuel cell system;
determining the flow rate of air in the fuel cell system;
metering a specified dose of water to the inlet of the compressor.

15. The method of operating a fuel cell air management system of claim 13 including the steps of:
determining a temperature of air in the fuel cell system;
determining a pressure of air in the fuel cell system;
determining the flow rate of air in the fuel cell system;
metering a specified dose of water to the outlet of the compressor.

16. The method of operating a fuel cell air management system of claim 13 including the steps of:
determining a temperature of air in the fuel cell system;
determining a pressure of air in the fuel cell system;
determining the flow rate of air in the fuel cell system;
metering a specified dose of water to the outlet of the recuperator.

17. The method of operating a fuel cell air management system of claim 13 including the steps of:
determining a temperature of air in the fuel cell system;
determining a pressure of air in the fuel cell system;
determining the flow rate of air in the fuel cell system;
metering a specified dose of water to the inlet of the compressor and to the outlet of the recuperator.

18. The method of operating a fuel cell air management system of claim 13 including the steps of:
providing a motor cooling pump connected to the electric machine and an inverter of the electric machine;
cooling the electric machine and inverter.

19. The method of operating a fuel cell air management system of claim 13 wherein the step of transferring the heat to the exhaust of the recuperator increases the enthalpy in the fuel cell air management system and lessens a cooling requirement of the intercooler.

20. The method of operating a fuel cell air management system of claim 13 including the step of decoupling the expander and the compressor wherein the expander and compressor are driven at different speeds.
